(19) United States
(12) Patent Application Publication
(10) Pub. No.: US 2024/0329930 A1
(43) Pub. Date: Oct. 3, 2024

(54) HETEROGENEOUS MULTI-FUNCTIONAL RECONFIGURABLE PROCESSING-IN-MEMORY ARCHITECTURE

(71) Applicants: GEORGE MASON UNIVERSITY, Fairfax, VA (US); The Regents of the University of California, Oakland, CA (US)

(72) Inventors: Sai Manoj Pudukotai Dinakarrao, Herndon, VA (US); Houman Homayoun, Davis, CA (US); Sathwika Bavikadi, Fairfax, VA (US)

(21) Appl. No.: 18/425,533

(22) Filed: Jan. 29, 2024

Related U.S. Application Data
(60) Provisional application No. 63/493,319, filed on Mar. 31, 2023.

(51) Int. Cl. G06F 7/523; G06F 7/50

(52) U.S. Cl. CPC G06F 7/523; G06F 7/50

(57) ABSTRACT

A processing-in-memory (PIM) system includes a plurality of PIM clusters interconnected by a router in one or more dynamic random-access memory (DRAM) banks. The PIM clusters include one or more multiply and accumulate (MAC) processing elements including a plurality of MAC lookup table cores operatively configured to perform arithmetic logic, and one or more special function (SF) processing elements, wherein the one or more SF processing elements including a plurality of SF lookup table cores operatively configured to perform one or more machine learning activation functions. The MAC lookup tables include a first arithmetic logic unit (ALU) lookup table core type operatively configured to perform addition or multiplication operations, and a second ALU lookup table core type operatively configured to simultaneously perform both addition and multiplication operations. The MAC lookup table cores and SF lookup table cores are configured to perform convolutional neural network acceleration.

### CROSS-REFERENCE TO RELATED APPLICATIONS

This application is a Non-Provisional patent application of, and claims the benefit of and priority to, Provisional Patent Application No. 63/493,319, filed on Mar. 31, 2023, and entitled “HETEROGENEOUS MULTI-FUNCTIONAL RECONFIGURABLE PROCESSING-IN-MEMORY ARCHITECTURE,” the disclosure of which is incorporated by reference as if the same were fully set forth herein.

### STATEMENT REGARDING FEDERALLY SPONSORED RESEARCH

This invention was made with government support under grant numbers 2228239 and 2228240 awarded by the National Science Foundation. The government has certain rights in the invention.

### TECHNICAL FIELD

The present systems, processes, devices, and apparatuses relate generally to computer architectures, and more specifically to heterogeneous multi-functional reconfigurable processing-in-memory (PIM) architectures.

### BACKGROUND

Conventional computer architectures, such as the von-Neumann architecture, are unequipped to support the growing trend in machine learning, artificial intelligence, big-data applications and computing processes of the like. By nature of their design, these conventional computer architectures physically separate computer memory from processing units, which requires retrieving data from the separated computer memory prior to processing. These conventional computer architectures simply cannot move and process data at the scale required for machine learning and artificial intelligence applications while also being efficient with respect to energy consumption, memory, latency, execution time, etc.

Custom-designed accelerators, such as application specific integrated circuits (ASICs), can alleviate energy and latency problems in conventional computer architectures, but their custom design also results in extremely low flexibility for use in anything other than the specific application for which they were designed. Field-programmable gate arrays (FPGAs) can alleviate the flexibility problem given FPGAs can be reprogrammed; however, FPGAs are not energy efficient and introduce other complexity and volatility challenges. Recent advances in processing-in-memory (PIM), In-Memory Computing (IMC), and near-data processing (NDP) computing designs have also contributed to improvements in latency and data transfer bottlenecks, but other issues like programmability, energy efficiency, execution time, and memory costs, still remain problematic as new computing architectures and systems are developed in response to the growing demand for compute necessitated by artificial intelligence and machine learning applications. Therefore, there is a long-felt but unresolved need for heterogeneous multi-functional reconfigurable processing-in-memory architectures.

### BRIEF SUMMARY OF THE DISCLOSURE

Briefly described, and according to one embodiment, aspects of the present disclosure generally relate to computer architectures. More specifically, embodiments of the present disclosure relate to heterogeneous multi-functional reconfigurable PIM architectures.

According to at least one embodiment, the heterogeneous multifunctional reconfigurable PIM architecture (also referred to throughout the present disclosure simply as “the PIM architecture”) as discussed herein is specifically configured to accelerate computing processes such as machine learning (ML) and deep learning (DL) calculations. In various embodiments, the heterogeneous multifunctional reconfigurable PIM architecture is specifically configured to accelerate deep neural networks (DNNs) and convolutional neural networks (CNNs). As will be understood by one of skill in the art, computing hardware is often a limiting factor with respect to performance in ML/DL applications, such as DNNs and CNNs. Moreover, processing ML/DL applications typically requires performing compute-intensive arithmetic calculations, such as multiply and accumulate (MAC) operations, which typically includes using logic gates to multiply two numbers and then add the product to another number. A substantial amount of CNN processing time and energy is spent performing MAC operations. In certain embodiments, other computations involved in ML applications such as activation functions may need specialized units such as digital signal processors (DSPs) for efficient processing. Accordingly, aspects of the disclosed embodiments aim to more efficiently perform MAC operations in ML/DL applications by implementing lookup-tables to perform MAC operations in lieu of logic-gate-based arithmetic.

In at least one example, embodiments of the present disclosure include a dynamic random-access memory (DRAM) based multifunctional lookup table (LUT) based reconfigurable PIM architecture that supports existing and emerging ML/DL applications with low overheads and high programmability. The disclosed architecture includes multiple processing elements (or PEs) arranged in a cluster, and each cluster can be embedded with a plurality of heterogeneous, multifunctional, and reconfigurable LUT cores. In various embodiments, each cluster can include various LUT core types, such that each LUT core type is operatively configured to perform one or more specific and distinct computing tasks. In particular embodiments, each cluster can include three LUT core types: an arithmetic logic unit (ALU) LUT core; a special ALU (S-ALU) LUT core; and a special-function (SF) LUT core.

According to various aspects of the present disclosure, and as will be discussed in greater detail below, each of the LUT core types are configured to perform distinct operations (thus, the LUT cores are heterogeneous) and the LUT cores can provide multiple outputs corresponding to multiple functionalities in a multiplexed manner (thus, the LUT cores are multifunctional). In various embodiments, the disclosed solution not only reduces number of LUTs required for running ML/DL applications, but also increases the utilization efficiency and functional support offered by LUTs.

In one embodiment, the ALU-LUT cores are operatively configured and programmed to implement MAC operations (such as multiplication and addition) in the PIM. In particular embodiments, the S-ALU-LUTs can provide multiple outputs relating to different functionalities, simultaneously, performed on the same input data, and without requiring different LUT designs for different functionalities. For example, a S-ALU-LUT core can be programmed such that, in a single clock cycle, the S-ALU-LUT core can perform both multiplication and addition calculations on the same given input, thus providing the output of both operations without the need of programming two cores separately to do multiplication and addition operations. In various embodiments, this multifunctional LUT core architecture design results in optimized area and power overheads.

In at least one embodiment, the SF-LUTs can be specifically configured to implement special-function operations including activation functions such as hyperbolics, sigmoid, and rectified linear unit (ReLU) operations. According to various aspects of the present disclosure, given ML/DL applications generally require performing each of the operations discussed above in connection with the ALU-LUT cores (MAC operations, activation operations such as sigmoid, hyperbolic, tangents, and ReLU, etc.), the S-ALU-LUT cores, and the SF-LUT cores, embodiments of the present disclosure include a multi-core architecture in which at least one of each LUT core type is embedded. As shown in the drawings and as discussed throughout the present disclosure, the PIM architecture can include nine cores; however, embodiments of the disclosed PIM architecture are not intended to be limited to nine LUT cores, and embodiments of the disclosed PIM architecture can be configured to include any appropriate number of LUT cores.

According to various aspects of the present disclosure, the disclosed PIM architecture can be adopted in systems that perform compute-intensive operations under low-power and high-performance requirements, such as edge computing, mobile applications, internet of things (IoT) based devices, image processing/computer vision-based AI systems such as drones and autonomous vehicles, data centers, cybersecurity systems and applications, etc.

In various embodiments, the PIM architecture design is technically advantageous, as compared to conventional systems, with respect to energy efficiency, area overheads, and processing performance. In one embodiment, implementing multifunctional LUTs as disclosed herein allows for the PIM architecture to include fewer LUTs (that perform multiple operations) as compared to having multiple LUTs to support multiple functions. The output of the LUTs can be obtained in a time-multiplexed manner. Multiple heterogeneous LUTs provide multiple functionalities at the same time instance. In various embodiments, the disclosed PIM architecture improves performance at the cost of area.

Moreover, throughout the present disclosure, the PIM architecture is discussed as being DRAM-based; however, the disclosed embodiments are not intended to be limited to only DRAM-type computer memory. DRAM is generally the most widely used memory technology for manufacturing external memory devices due to its higher memory density, lower power consumption, and lower cost of production compared to other memory technologies, and thus embodiments of the present disclosure are DRAM-based. However, embodiments of the present disclosure can include other types of computer memory, such as static random-access memory (SRAM), as well as non-volatile memory technologies like Resistive RAM (ReRAM), Magnetic RAM (STT/SOT-MRAM), Spin-Transistor Torque Magnetic Tunnel Junction (STT-MTJ) memories, and others.

In one embodiment, the present disclosure discusses a plurality of processing-in-memory (PIM) clusters interconnected by a router in one or more dynamic random-access memory (DRAM) banks, wherein each PIM cluster of the plurality of PIM clusters includes: one or more multiply and accumulate (MAC) processing elements, wherein the one or more MAC processing elements include a plurality of MAC lookup table cores, and wherein each MAC lookup table core of the plurality of MAC lookup table cores is operatively configured to perform arithmetic logic in response to receiving a pair of data inputs; and one or more special function (SF) processing elements, wherein the one or more SF processing elements include a plurality of SF lookup table cores, and wherein each SF lookup table core of the plurality of SF lookup table cores is operatively configured to perform one or more machine learning activation functions in response to receiving a single data input.

In various embodiments, the plurality of MAC lookup table cores further includes: one or more of a first arithmetic logic unit (ALU) lookup table core type, wherein the one or more of the first ALU lookup table core type is operatively configured to perform addition or multiplication operations on a respective pair of received 4-bit inputs in a single clock cycle; and one or more of a second ALU lookup table core type, wherein the one or more of the second ALU lookup table core type is operatively configured to simultaneously perform both addition and multiplication operations on a respective pair of received 4-bit inputs in a single clock cycle.

In certain embodiments, a MAC multiplexer is operatively configured to determine whether the one or more of the first ALU lookup table core type performs an addition or multiplication operation. In a particular embodiment, the one or more machine learning activation functions include sigmoid functions, rectified linear unit functions, or hyperbolic functions. Moreover, in at least one embodiment, a SF multiplexer is operatively configured to determine which function, of the one or more machine learning activation functions, the plurality of SF lookup tables performs.

In an example embodiment, the plurality of MAC lookup table cores and the plurality of SF lookup table cores are heterogeneously programmed to perform distinct operations. In particular embodiments, a particular PIM cluster of the plurality of PIM clusters includes eight MAC processing elements and one SF processing element. Further, in one example, the particular PIM cluster is operatively configured to perform a MAC operation in nine clock cycles. According to various aspects of the present disclosure, and in response to performing the MAC operation, the particular PIM cluster is further operatively configured to perform a machine learning activation function operation in one clock cycle. In various embodiments, the MAC operation and the machine learning activation function operation accelerate processing of a convolutional neural network.

In one embodiment, the present disclosure discusses a device, including: one or more multiply and accumulate (MAC) in-memory processing elements, wherein the one or more MAC in-memory processing elements include a plurality of MAC lookup table cores, wherein each MAC lookup table core of the plurality of MAC lookup table cores is operatively configured to perform arithmetic logic in response to receiving a pair of data inputs, and wherein the plurality of MAC lookup table cores further includes: one or more of a first arithmetic logic unit (ALU) lookup table core type, wherein the one or more of the first ALU lookup table core type is operatively configured to perform addition or multiplication operations on a respective pair of received 4-bit inputs in a single clock cycle; and one or more of a second ALU lookup table core type, wherein the one or more of the second ALU lookup table core type is operatively configured to simultaneously perform both addition and multiplication operations on a respective pair of received 4-bit inputs in a single clock cycle.

In various embodiment, a MAC multiplexer is operatively configured to determine whether the one or more of the first ALU lookup table core type performs an addition or multiplication operation. In certain embodiments, the device further includes one or more special function (SF) in-memory processing elements, wherein the one or more SF in-memory processing elements include a plurality of SF lookup table cores, and wherein each SF lookup table core of the plurality of SF lookup table cores is operatively configured to perform one or more machine learning activation functions in response to receiving a single data input. In particular embodiments, the one or more machine learning activation functions include sigmoid functions, rectified linear unit functions, or hyperbolic functions.

According to various aspects of the present disclosure, a SF multiplexer is operatively configured to determine which function, of the one or more machine learning activation functions, the plurality of SF lookup tables performs. In at least one embodiment, the plurality of MAC lookup table cores and the plurality of SF lookup table cores are heterogeneously programmed to perform distinct operations. In particular embodiments, eight MAC in-memory processing elements and one SF in-memory processing element are interconnected in one or more dynamic random-access memory (DRAM) banks DRAM via a router to form a processing-in-memory (PIM) cluster. Further, in an example embodiment, the PIM cluster is operatively configured to perform a MAC operation in nine clock cycles.

According to various aspects of the present disclosure, and in response to performing the MAC operation, the PIM cluster is further operatively configured to perform a machine learning activation function operation in one clock cycle. Moreover, in particular embodiments, the MAC operation and the machine learning activation function operation accelerate processing of a convolutional neural network.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram illustrating an example PIM architecture implementation, according to one aspect of the present disclosure;

FIG. 2 is a diagram illustrating an example PIM architecture, according to one aspect of the present disclosure;

FIGS. 3A and 3B are diagrams illustrating example processing element core designs, according to one aspect of the present disclosure;

FIG. 4 is a diagram illustrating an example design for intra-cluster and inter-cluster communications, according to one aspect of the present disclosure;

FIG. 5A is a schematic of an example data flow model, and FIG. 5B is an example mapping of the data flow model shown in FIG. 5A, according to one aspect of the present disclosure;

FIG. 6 is a graph illustrating example PIM architecture performance results and evaluations, according to one aspect of the present disclosure;

FIG. 7 is a graph illustrating example PIM architecture performance results and evaluations, according to one aspect of the present disclosure; and

FIG. 8 is a graph illustrating example PIM architecture performance results and evaluations, according to one aspect of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to computer architectures. More specifically, embodiments of the present disclosure relate to heterogeneous multifunctional reconfigurable PIM architectures.

According to at least one embodiment, the heterogeneous multifunctional reconfigurable PIM architecture (also referred to throughout the present disclosure simply as “the PIM architecture”) as discussed herein is specifically configured to accelerate computing processes such as machine learning (ML) and deep learning (DL) calculations. In various embodiments, the heterogeneous multifunctional reconfigurable PIM architecture is specifically configured to accelerate deep neural networks (DNNs) and convolutional neural networks (CNNs). As will be understood by one of skill in the art, computing hardware is often a limiting factor with respect to performance in ML/DL applications, such as DNNs and CNNs. Moreover, processing ML/DL applications typically requires performing compute-intensive arithmetic calculations, such as multiply and accumulate (MAC) operations, which typically includes using logic gates to multiply two numbers and then add the product to another number. A substantial amount of CNN processing time and energy is spent performing MAC operations. In certain embodiments, other computations involved in ML applications such as activation functions may need specialized units such as digital signal processors (DSPs) for efficient processing. Accordingly, aspects of the disclosed embodiments aim to more efficiently perform MAC operations in ML/DL applications by implementing lookup-tables to perform MAC operations in lieu of logic-gate-based arithmetic.

In at least one example, embodiments of the present disclosure include a dynamic random-access memory (DRAM) based multifunctional lookup table (LUT) based reconfigurable PIM architecture that supports existing and emerging ML/DL applications with low overheads and high programmability. The disclosed architecture includes multiple processing elements (or PEs) arranged in a cluster, and each cluster can be embedded with a plurality of heterogeneous, multifunctional, and reconfigurable LUT cores. In various embodiments, each cluster can include various LUT core types, such that each LUT core type is operatively configured to perform one or more specific and distinct computing tasks. In particular embodiments, each cluster can include three LUT core types: an arithmetic logic unit (ALU) LUT core; a special ALU (S-ALU) LUT core; and a special-function (SF) LUT core.

According to various aspects of the present disclosure, and as will be discussed in greater detail below, each of the LUT core types are configured to perform distinct operations (thus, the LUT cores are heterogeneous) and the LUT cores can provide multiple outputs corresponding to multiple functionalities in a multiplexed manner (thus, the LUT cores are multifunctional). In various embodiments, the disclosed solution not only reduces number of LUTs required for running ML/DL applications, but also increases the utilization efficiency and functional support offered by LUTs.

In one embodiment, the ALU-LUT cores are operatively configured and programmed to implement MAC operations (such as multiplication and addition) in the PIM. In particular embodiments, the S-ALU-LUTs can provide multiple outputs relating to different functionalities, simultaneously, performed on the same input data, and without requiring different LUT designs for different functionalities. For example, a S-ALU-LUT core can be programmed such that, in a single clock cycle, the S-ALU-LUT core can perform both multiplication and addition calculations on the same given input, thus providing the output of both operations without the need of programming two cores separately to do multiplication and addition operations. In various embodiments, this multifunctional LUT core architecture design results in optimized area and power overheads.

In at least one embodiment, the SF-LUTs can be specifically configured to implement special-function operations including activation functions such as hyperbolics, sigmoid, and rectified linear unit (ReLU) operations. According to various aspects of the present disclosure, given ML/DL applications generally require performing each of the operations discussed above in connection with the ALU-LUT cores (MAC operations, activation operations such as sigmoid, hyperbolic, tangents, and ReLU, etc.), the S-ALU-LUT cores, and the SF-LUT cores, embodiments of the present disclosure include a multi-core architecture in which at least one of each LUT core type is embedded. As shown in the drawings and as discussed throughout the present disclosure, the PIM architecture can include nine cores; however, embodiments of the disclosed PIM architecture are not intended to be limited to nine LUT cores, and embodiments of the disclosed PIM architecture can be configured to include any appropriate number of LUT cores.

According to various aspects of the present disclosure, the disclosed PIM architecture can be adopted in systems that perform compute-intensive operations under low-power and high-performance requirements, such as edge computing, mobile applications, internet of things (IoT) based devices, image processing/computer vision-based AI systems such as drones and autonomous vehicles, data centers, cybersecurity systems and applications, etc.

In various embodiments, the PIM architecture design is technically advantageous, as compared to conventional systems, with respect to energy efficiency, area overheads, and processing performance. In one embodiment, implementing multifunctional LUTs as disclosed herein allows for the PIM architecture to include fewer LUTs (that perform multiple operations) as compared to having multiple LUTs to support multiple functions. The output of the LUTs can be obtained in a time-multiplexed manner. Multiple heterogeneous LUTs provide multiple functionalities at the same time instance. In various embodiments, the disclosed PIM architecture improves performance at the cost of area.

Moreover, throughout the present disclosure, the PIM architecture is discussed as being DRAM-based; however, the disclosed embodiments are not intended to be limited to only DRAM-type computer memory. DRAM is generally the most widely used memory technology for manufacturing external memory devices due to its higher memory density, lower power consumption, and lower cost of production compared to other memory technologies, and thus embodiments of the present disclosure are DRAM-based. However, embodiments of the present disclosure can include other types of computer memory, such as static random-access memory (SRAM), as well as non-volatile memory technologies like Resistive RAM (ReRAM), Magnetic RAM (STT/SOT-MRAM), STT-MTJ memory and others.

### Example Embodiments

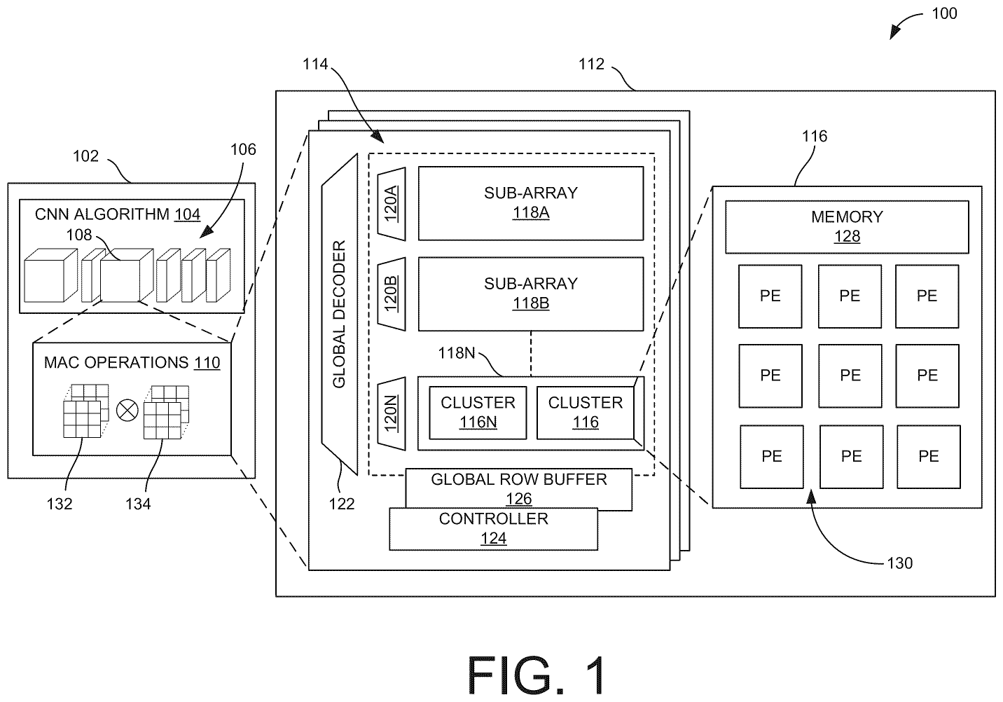

Referring now to the figures, for the purposes of example and explanation of the fundamental processes and components of the disclosed systems and processes, reference is made to FIG. 1, which is a diagram illustrating an example processing-in-memory (PIM) architecture implementation 100. As will be understood and appreciated, the example PIM architecture 100 shown in FIG. 1 represents merely one approach or embodiment of the present system, and other aspects are used according to various embodiments of the present system.

In one embodiment, and as show in FIG. 1, the PIM architecture implementation 100 includes a software domain 102, or software application(s), in which a CNN algorithm 104 can be configured to operate. As will be understood by one of ordinary skill in the art, CNN algorithms include various convolution layers 106, or processing layers (e.g., convolutional layers, activation layers, pooling layers, fully-connected layers, etc.), each of which perform a specific function within the CNN. In a particular embodiment, a convolutional layer 108 in the CNN algorithm 104 is configured to perform multiply and accumulate (MAC) operations 110, which generally include performing arithmetic calculations on an input matrix 132 and a weighted matrix 134. In various embodiments, the MAC operations 110 typically require repeated complex mathematical calculations, which not only is time consuming but also requires large amounts of energy and general compute.

In at least one embodiment, the present disclosure describes an inventive solution to the problem mentioned above with respect to compute-intensive MAC operations in CCNs. As shown in FIG. 1, rather than performing the MAC operations 110 in a traditional logic gate-based architecture, the present disclosure instead describes performing CNN calculations and operations, such as the MAC operations 110, in a hardware domain 112. More specifically, the present disclosure describes performing CNN calculations and related operations in a PIM architecture that includes multifunctional and heterogeneously programmed lookup table-based processing elements (also referred to herein as “PEs,” “processing cores,” or “cores”).

Continuing with the discussion of FIG. 1, and referring specifically now to the hardware domain 112 in which the CNN calculations and operations (namely the MAC operations 110) are performed, the hardware domain 112 includes memory bank(s) 114 which can include DRAM or another appropriate type of computer memory. According to various aspects of the present disclosure, the MAC operations 110 can be routed to one or more PIM clusters 116 within the memory bank 114 for in-memory processing. As will be discussed in greater detail below, the PIM clusters 116 include a plurality of lookup table-based processing elements (represented in FIG. 1 as “PE”) that are both multifunctional and heterogeneously configured such that the lookup tables can perform the MAC operations in lieu of traditional logic gate-based calculations.

As will be understood by one of ordinary skill in the art, computer memory is generally designed in a hierarchical structure in which an entire block of memory on a computer memory chip is referred to as a rank, and within ranks are a plurality of banks (such as the memory bank 114), and furthermore within banks are memory sub-arrays. As illustrated in the present embodiment, the memory bank 114 includes one or more sub-arrays 118A, 118B, and 118N, which are each operatively connected to decoders 120A, 120B, and 120N, respectively, which are configured to select or determine memory addresses within the DRAM sub-arrays based on received inputs. In various embodiments, the decoders 120A-120N can also be operatively connected to a global decoder 122 which, for example, can select from the memory banks 114 based on received inputs. In particular embodiments, the decoders 120A-120N and the global decoder 122 can receive their respective inputs from the controller 124, which can be operatively configured to manage the flow of data to and from the memory bank 114. In at least one embodiment, the memory bank 114 can be operatively connected to a global row buffer 126, which operates like cache memory within the DRAM and allows for data from multiple memory banks to be read in parallel.

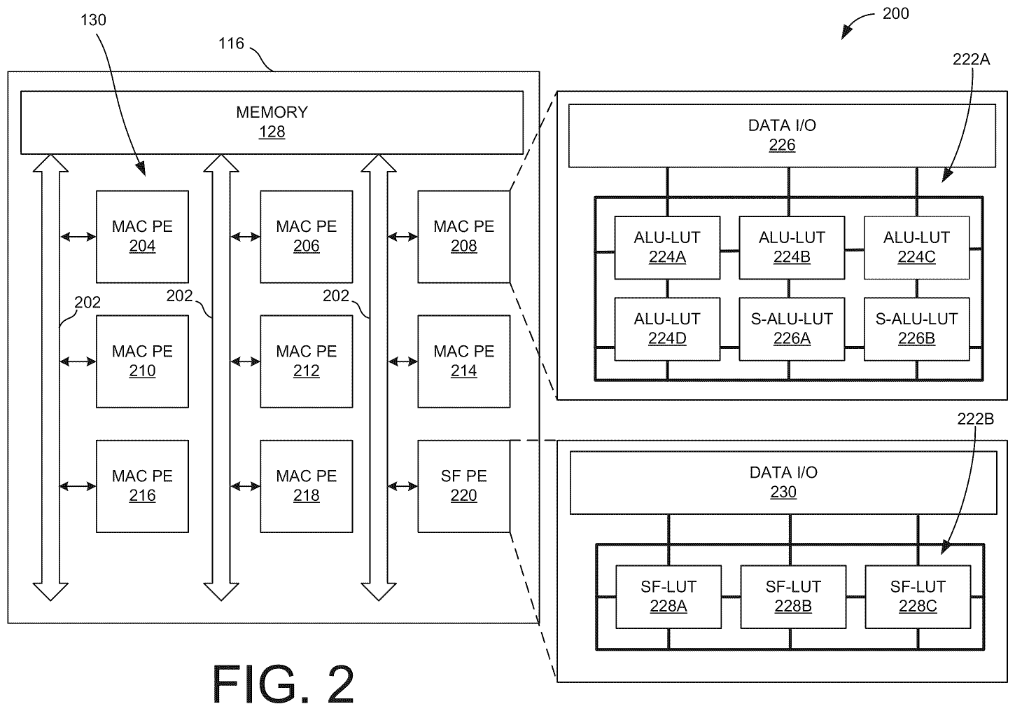

As mentioned briefly above, the sub-arrays 118A-118N can be operatively configured to include one or more PIM clusters 116-116N, which include a plurality of lookup table-based processing elements (or “PEs”) that are both multifunctional and heterogeneously configured such that the lookup tables can perform the MAC operations (and other special functions) in lieu of traditional logic-gate-based calculations. As illustrated in FIG. 1, the PIM cluster 116 includes memory 128 (a plurality of DRAM cells) in which a plurality, or cluster, of PEs are configured. In at least one embodiment, a PE cluster 130 can include nine PEs; however, a cluster can include two, three, six, ten, twelve, twenty-five, forty-nine, or any appropriate number of PEs, and the present disclosure should not be construed as limiting a PE cluster 130 to nine PEs. As will be discussed in greater detail below in association with the description of FIG. 2, the PE cluster 130 can include a plurality of lookup tables that are each operatively configured to perform the types of arithmetic calculations required for operating convolutional neural networks (CNNs) and other similar types of machine learning processes. In particular embodiments, each PE in the PE cluster 130 can be heterogeneously configured, such that one PE is operatively configured to perform XOR operations (parity or “carry-less” addition), another PE is operatively configured to perform AND operations (multiplication), and another PE is operatively configured to perform special functions such as sigmoids, hyperbolics, rectified linear unit (ReLU) functions, and other machine learning activation functions. As will be understood by one of ordinary skill in the art, machine learning activation functions are used in neural networks (and other machine learning applications) to determine whether a neuron in the neural network should be activated based on a set of weighted input values. Further, in various embodiments, machine learning activation functions can map input values to a known range of output values, such a value between 0 and 1. In particular embodiments, designing the PIM architecture to include heterogeneously configured cores reduces, or eliminates, the need for lookup tables within the PEs to be reconfigured prior to performing different functions. In addition to each PE in the PE cluster 130 being heterogeneously configured, the PEs can also be configured such that they are multifunctional. In various embodiments, the multifunctional PEs can perform both XOR and AND operations (multiplication and addition), simultaneously, for the same input data. The designs for the various types of PEs implemented within the PIM architecture are described in more detail below in association with the discussion of FIG. 2.

Turning now to FIG. 2, a diagram illustrating an example PIM architecture 200 is shown, according to one aspect of the present disclosure. In at least one embodiment, the PIM architecture 200 as shown in FIG. 2 illustrates, in greater detail, the PIM architecture's lookup table-based (LUT-based) design and configuration. For example, FIG. 2 illustrates the PIM cluster 116 as introduced above in connection with FIG. 1, but with additional detail. In the present embodiment, the PIM cluster 116 is shown including the memory 128 with memory buses 202 connected thereto. Moreover, operatively connected to the memory buses 202 is the PE cluster 130 including a plurality of processing elements. In at least one embodiment, the processing elements as described herein can be individual units of computer memory (e.g., DRAM) that are configured with lookup tables, and the lookup tables are configured to perform arithmetic and machine learning activation functions. In various embodiments the processing elements 204, 206, 208, 210, 212, 214, 216, and 218, are each multiply and accumulate (MAC) PEs, such that they are configured to perform one or more functions associated with MAC operations, which typically account for the majority of compute in a CNN's convolutional layer. In various embodiments, the processing element 220 can be operatively configured as a special function PE, or SF-PE. According to various aspects of the present disclosure, each processing element of the PE cluster 130 includes a lookup table, or LUT. In one example, a LUT is a pre-configured or pre-programmed truth table that includes all possible outputs for a particular function. Accordingly, given one or more input values (the size and number of inputs can vary based on the function and/or LUT design), a LUT can produce an output for the function without the need for runtime computation (the input value(s) are mapped to the output value(s)).

In one embodiment, the PIM architecture 200 includes a plurality of LUT cores 222A and a plurality of LUT cores 222B. In a particular embodiment, the plurality of LUT cores 222A includes arithmetic logic unit (ALU) LUT cores 224A, 224B, 224C, and 224D, as well as special arithmetic logic unit (S-ALU) LUT cores 226A and 226B. In various embodiments, the plurality of LUT cores 222B includes special function (SF) LUT cores 228A, 228B, and 228C. In various embodiments, the ALU-LUT, S-ALU-LUT, and the SF-LUT cores are also referred to throughout the present disclosure as multifunctional LUTs (M-LUTs).

As illustrated in FIG. 2, the MAC PEs 204, 206, 208, 210, 212, 214, 216, and 218 can include two different reconfigurable, heterogeneous, and multifunctional LUT cores (ALU-LUT, and S-ALU-LUT) which can be operatively connected by a router. In one embodiment, the MAC PE can be configured to include of a total of six heterogeneous cores (4 ALU-LUT cores and 2 S-ALU-LUT cores).

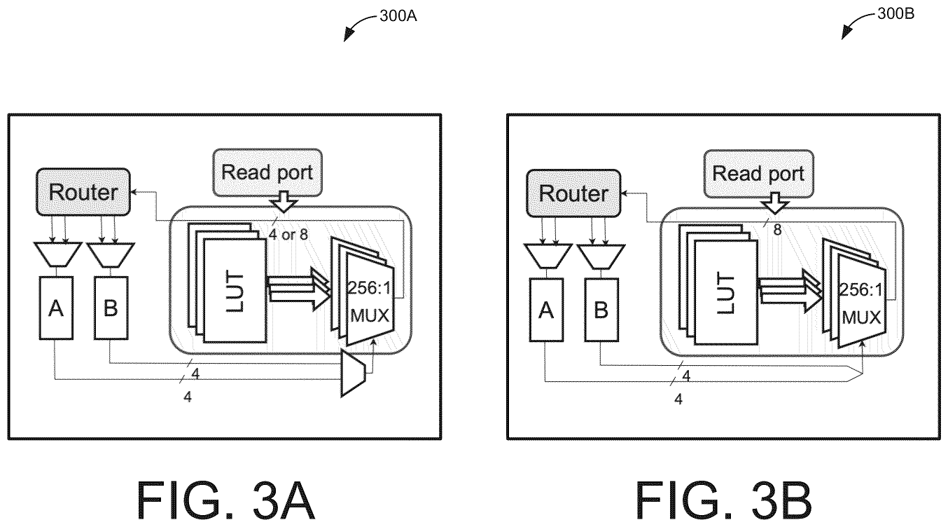

In various embodiments, the ALU-LUT cores 224A-D can be operatively configured to perform 4-bit AND or XOR operations on a pair of 4-bit data inputs, and in turn provide 4-bit output. In at least one embodiment, a multiplexer can be used to select the functionality required for the different operations of the CNN algorithm, for example, to either perform XOR or AND operations on the inputs (as illustrated in FIG. 3A). Accordingly, and based on the multiplexer input, the multifunctional core performs either AND or XOR operation on the input data. In a particular embodiment, a cluster, such as the PIM cluster 116 as shown in the present embodiment, can be configured to include 6 ALU-LUT cores.

Still referring to FIG. 2, the S-ALU-LUT cores 226A-B can be operatively configured and programmed such that the output includes two entirely different operations (XOR and AND) on the same pair of inputs. In various embodiments, while the S-ALU-LUT core supports the same operations (XOR and AND) as the ALU-LUT core, its functionality is entirely different. In one embodiment, the S-ALU-LUT core is operatively configured for special scenarios in which, for example, a step in a decomposed MAC operation requires both XOR and AND operations for the same input data (such as during the accumulation process). In various embodiments, the S-ALU-LUT core can be programmed to produce 8-bit output data for a pair of 4-bit inputs, where the upper half of the core output represents the 4-bit XOR operation of the input data and the lower half represents the 4-bit AND operation of the same input data (as illustrated in FIG. 3B). According to various aspects of the present disclosure, without the need to create separate LUT cores for various purposes, this unique S-ALU-LUT core is configured to simultaneously and concurrently deliver several outputs pertaining to different functionalities.

In various embodiments, the SF PE 220 and SF-LUT cores 228A-C are operatively configured to perform special function operations such as activation (machine learning activation functions), pooling, and batch normalization, which can be used for CNN acceleration. In one embodiment, the PIM cluster 116 includes only one SF-LUT core, which is programmed to perform 8-bit special-function activation operations such as sigmoid, hyperbolic, and ReLU using 8-bit LUT cores. According to various aspects of the present disclosure, elements of the SF-LUT core design may be similar to the ALU-LUT in that a multiplexer is used to select the different activation operations to be implemented in SF-LUT based on the input data (as illustrated in FIG. 3A). In various embodiments, the SF-LUT core is programmed and configured to produce 8-bit output on 8-bit input. In at least one embodiment, based on the operands received by the multiplexer, the multifunctional SF-LUT core is configured to perform operations on the inputs such as sigmoid, hyperbolic, or ReLU activation functions. In at least one embodiment, the special function processing elements, such as the SF PE 220, can receive (as an input) the output of the MAC operations performed by the MAC PEs, and the special function processing elements can furthermore determine whether a corresponding neuron in the CNN should be activated based on the MAC operation output.

In one embodiment, the LUT cores perform multifunctional programmable operations on a pair of 4-bit (for ALU cores) or a single 8-bit input data (for SF cores). In various embodiments, each PE including a combination of ALU-LUTs, S-ALU-LUTs, and SF-LUTs, can be programmed to perform a wide range of operations such as multiply and accumulate, substitution, comparison, bit-wise logic operations, hyperbolics, sigmoid, and ReLU activation and pooling operations. According to various aspects of the present disclosure, the disclosed PIM architecture includes an array of PEs to form one or more clusters that can be utilized to implement different layers of CNNs and DNNs, such as convolutional layers, fully-connected layers, activation, and pooling layers for various CNN inference applications.

As will be understood by one of ordinary skill in the art, a substantial percentage of operations carried out in a CNN/DNN algorithm are performed by the convolutional layers. These convolutional layers perform convolution operations that are fundamentally matrix multiplications. According to various aspects of the present disclosure, the MAC PEs disclosed herein are configured such that the convolution operations can be decomposed and performed with a chain of multiplication and accumulation operations inside each MAC PE. In various embodiments, the MAC PE outputs can be normalized in the SF PE 220. In one embodiment, the SF PE 220 can also support the pooling and the activation operations like ReLU, hyperbolic, and sigmoid. Accordingly, in one embodiment, the disclosed PIM architecture supports an array of these PEs (MAC PEs and SF PEs) to form a cluster that can be operatively configured to implement different layers of CNNs and DNNs.

According to various aspects of the present disclosure, the PIM clusters may include various architecture designs. In one embodiment, the PIM clusters may be designed to include nine PEs in a 3×3 arrangement, such as the PIM cluster 116. In various embodiments, this clustered architecture includes eight MAC PEs and one SF PE, and can support eight MAC operations and a special function operation at the same time. In various embodiments, this cluster arrangement is adapted to support smaller-scale MAC operations, which can be implemented mainly in fully-connected layers of the CNN.

According to various aspects of the present disclosure, and in order to scale up the size of the operands, twenty-five PEs can be aggregated and arranged in a 5×5 arrangement to form a cluster. In a particular embodiment, this cluster design supports the design exploration of the twenty-five PEs in a 5×5 grid manner. In certain embodiments, this cluster architecture includes twenty-four MAC PEs and one SF PE, and can support twenty-four MAC operations and a special function operation at the same time. In at least one embodiment, this arrangement of clusters is adapted to support wider smaller-scale MAC operations, which can be implemented in the latter convolutional operation layers and fully-connected layers.

In certain embodiments, and to further scale up the size of the operands, forty-nine PEs can be combined into a cluster placed in a 7×7 arrangement. In one embodiment, this cluster facilitates the 7×7 grid-based design exploration of the forty-nine PEs, and the cluster architecture includes forty-eight MAC PEs and one SF PE which can support forty-eight MAC operations and a special function operation at the same time. In various embodiments, this cluster arrangement is adapted to support wider large-scale MAC operations, which can be implemented in the compute-intensive convolutional layers.

According to various aspects of the present disclosure, the disclosed PEs, such as the plurality of PEs 130, are independent in-memory processing units capable of performing complex operations with 8-bit fixed point precision by organizing a series of micro-operations across the heterogeneously programmed M-LUT cores in several operational stages. In various embodiments, the M-LUT core design in the PEs aims to facilitate intrinsic computational support to perform MAC operations, activation, and pooling operations. In a particular embodiment, the disclosed heterogeneous multifunctional LUT cores can perform any in-memory computation and can be utilized to implement different neural network layers for machine learning acceleration.

Still referring to FIG. 2, the MAC PE 208 is formed by six M-LUT cores (the plurality of LUT cores 222A), and the SF PE 220 is formed by three M-LUT cores (the plurality of LUT cores 222B), which are placed inside the memory banks to allow the quickest access to the memory data and to perform the in-memory operation with significantly lower latency. In various embodiments, six of these heterogeneous multifunctional M-LUT cores (ALU-LUT, S-ALU-LUT) inside the MAC PE and three of these heterogeneous multifunctional LUT cores (SF-LUT) inside the SF PE are programmed in a specific way to form a cluster. In certain embodiments, these PEs are interconnected by a routing mechanism in order to perform complex operations such as MAC operations, activation, pooling, and normalization operations required for CNN acceleration. As discussed throughout the present disclosure, these operations can be performed in a multi-staged pipeline by organizing a series of micro-operations across the heterogeneously programmed M-LUT cores. In various embodiments, the PIM core design, with respect to the number of cores in a PE, may be related to the minimal number of required cores to carry out 4-bit MAC operation without loss in performance.

In particular embodiments, and unlike preexisting systems, the LUT cores disclosed herein are heterogeneous multifunctional LUT cores, such that each LUT core is operatively configured and programmed to perform distinct operations from each other and to provide multiple outputs corresponding to multiple functionalities in a time-multiplexed manner. In various embodiments, this not only reduces the number of LUTs required to perform MAC operations, but also increases the utilization efficiency and functional support offered by LUTs.

In at least one embodiment, the ALU-LUT cores are specifically programmed and operatively configured to implement the MAC operations in the PIM. In particular embodiments, the special ALU (S-ALU) LUTs can provide multiple outputs relating to different functionalities simultaneously without the need to design different LUTs for different functionalities. For example, S-ALU-LUT cores can be programmed to perform multiplication and addition on the same input in a single clock cycle, thereby providing the output of both operations without the need to program two cores separately to do multiplication and addition operations. According to various aspects of the present disclosure, this multi-functionality results in optimized area and power overheads given less LUT cores are required to perform MAC operations (or other operations).

In various embodiments, the special-function (SF) LUTs are designed and operatively configured to implement special-function operations such as hyperbolics, sigmoid, and ReLU operations. According to various aspects of the present disclosure, in response to the ALU-LUT cores and S-ALU-LUT cores performing multiplication and addition operations on an input, the SF-LUT core may receive the output from the ALU-LUTs and S-ALU-LUTs as its input.

Turning now to FIGS. 3A and 3B, diagrams illustrating example PE core designs are shown, according to one aspect of the present disclosure. More specifically, in one embodiment, FIG. 3A illustrates an example core design for both ALU-LUT cores and SF-LUT cores, and FIG. 3B illustrates an example S-ALU-LUT core design. In various embodiments, aspects of the PE core and cluster designs may be similar to those discussed in U.S. Patent Publication No. 2022/0326958, filed on Apr. 11, 2022, and entitled “LOOK-UP TABLE CONTAINING PROCESSOR-IN-MEMORY CLUSTER FOR DATA-INTENSIVE APPLICATIONS,” which is incorporated by reference herein. However, the PIM architecture disclosed herein includes PE and cluster designs which include lookup tables that are heterogeneous and can generate multiple outputs for a single set of input data in a single clock cycle. For example, the LUT cores disclosed herein are multifunctional such that they can perform both multiplication and addition on the same input in a single clock cycle, which reduces the total number of LUTs required to perform MAC operations (and the like).

In various embodiments, the multifunctional LUTs disclosed herein are operatively configured to support data of various precision levels, and fewer LUTs are required for reduced precision operations. According to various aspects of the present disclosure, using lower precision LUT for computational operations leverages improved latency and energy efficiency without compromising CNN algorithm accuracy.

In at least one embodiment, the M-LUT-based core designs illustrated in FIGS. 3A and 3B are operatively configured to perform in-memory arithmetic operations such as addition, multiplication, comparison, substitution, and bit-wise logic operations. In various embodiments, these operations are implemented by utilizing 4-bit memory LUTs in a multi-stage pipeline. In one embodiment, each LUT can produce a 4-bit/8-bit data output for two input data operands with the size of 4-bit width. According to various aspects of the present disclosure, computer vision applications perform reliably at this precision with minimal accuracy loss compared to higher precision.

In particular embodiments, the LUTs are implemented using 8-bit 256-to-1 multiplexers. For example, in order to perform an activation operation with an 8-bit operand, the 8-bit multiplexer (MUX) in the PIM core is configured to perform a lookup operation and provide 8-bit output. In various embodiments, each LUT core can either support a single 8-bit operand (as shown in FIG. 3B) or a pair of 4-bit operands (as shown in FIG. 3A) in order to perform operations. In one embodiment, at least one advantage of the disclosed architecture is that the disclosed LUTs can be programmed to implement virtually any type of computation, which provides the LUTs with the functional flexibility required for implementing different operations required by deep learning applications, such as linear algebraic operations, activation, and pooling operations.

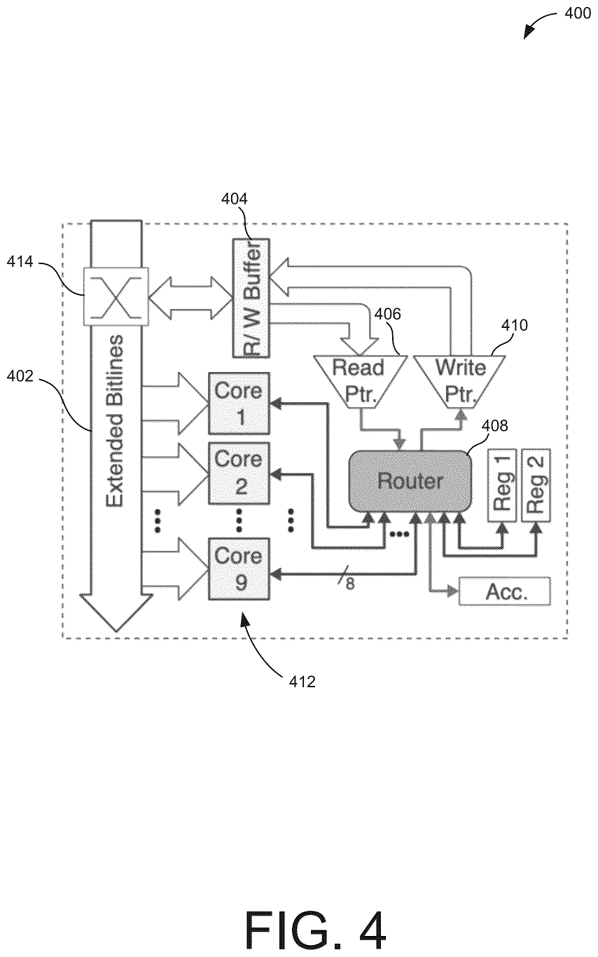

Referring now to FIG. 4, a diagram illustrating an example design 400 for intra-cluster and inter-cluster communications is shown, according to one aspect of the present disclosure.

In one embodiment, the PIM architecture includes of a plurality of processing elements, or clusters, arranged inside a DRAM bank. As shown in the present embodiment, the arrangement of cores, and the computing components operatively connected thereto, can represent example core and cluster designs. In particular embodiments, the clusters are operatively configured in rows inside the DRAM memory banks (and in between the memory subarrays), forming an overall 2-D array of cluster groups across a DRAM bank. In various embodiments, each cluster includes of a group of PEs configured to perform various in-memory operations. In at least one embodiment, the PEs are configured to be close in physical proximity to the memory sub-arrays to allow for rapid access to the memory data. As a result, in particular embodiment, clusters can instantly read and write data from and to an adjacent subarray, respectively. In various embodiments, these design characteristics allow for the disclosed PIM architecture to efficiently perform operations required for CNN algorithm processing by distributing the operation tasks among multiple clusters (which is more effective than implementing conventional in-memory buses or Network-on-Chip architectures (NoC's)).

In particular embodiments, the disclosed PIM architecture leverages a low-cost sub-array interlinking mechanism that interlinks the local bitlines (represented in the example design 400 as extended bitlines 402) of each subarray to the local bitlines of their respective adjacent subarrays via access transistors, which allows for low latency inter-cluster communication. In various embodiments, the contents of one subarray need not be routed through the memory controller to another subarray in the same bank, thus improving data transfer latency (with respect to conventional systems and architectures).

In at least one embodiment, the clusters are configured to read from, and write into, the memory sub-array via the memory sub-array's extended bitlines 402. In particular embodiments, the operands are read in large batches (i.e. 128 bytes) by the cluster's read/write buffer 404. In one example, a read pointer 406 allows the cluster router 408 to read 8-bit data pairs sequentially from the read/write buffer 404 during operations. According to various aspects of the present disclosure, and prior to writing outputs back into the memory, the outputs can be collected as a larger batch inside the read/write buffer 404 (via the write pointer 410). In various embodiments, the buffer content can then be forwarded to the sub-array row-buffer via the bitlines 402, to be written back into the memory.

In one embodiment, the example design 400 allows for a high-bandwidth bitline-parallel communication channel across the memory bank, and further allows the contents of an entire sub-array row to be transferred to another sub-array via single or multiple hops. In particular embodiments, the design 400 enables clusters located along the same set of interlinked bitlines to exchange data and thereby share a common operation task.

In various embodiments, the clusters can include multiple PEs interconnected by a router (such as the router 408). These clusters can be configured to execute complicated arithmetic or logical tasks over single or multiple stages by combining the capability of multiple PE functionalities. For example, each PE in a cluster can include a plurality of multifunctional LUT cores (also referred to herein as “M-LUT cores”), which provide in-memory computing capability. As shown the present embodiment, a plurality of multifunctional LUT cores 412 are operatively connected to both the extended bitlines 402 and the router 408. In one embodiment, the PE M-LUT cores 412 can be individually (and heterogeneously) programmed, thus enhancing the design flexibility to adapt to different applications. In various embodiments, the data flow within a PE includes a low-overhead all-to-all communication network. According to various aspects of the present disclosure, this is done by employing a crossbar switch architecture (represented as the crossbar switch 414 overlayed onto the bitlines 402), such that each M-LUT core within a PE can share the data operands to and among the M-LUT cores using a crossbar switch routing design.

In various embodiments, distributing the operands during every single stage in the operational stage is performed via the router 408. In one embodiment, the router 408 is configured to connect each M-LUT core in the plurality of cores 412 in order to access any M-LUT core data at any point of time during the execution. In particular embodiments, the router 408 enables parallel communication by connecting every component of the PE, including the M-LUT cores 412 and the read/write ports.

In certain embodiments, the memory read/write buffer 404 in a cluster can be configured to read the data input from memory and write outputs back into the memory in order to perform the operations for CNN acceleration (such as MAC operations). In at least one embodiment, the data communication among PEs inside the cluster is achieved through the routing mechanism, which allows for the disclosed PIM architecture to map and distribute tasks among multiple PEs with low complexity. Moreover, in various embodiments, different PEs inside the memory bank can execute parallel and independent tasks in a single instruction multiple data (SIMD) fashion.

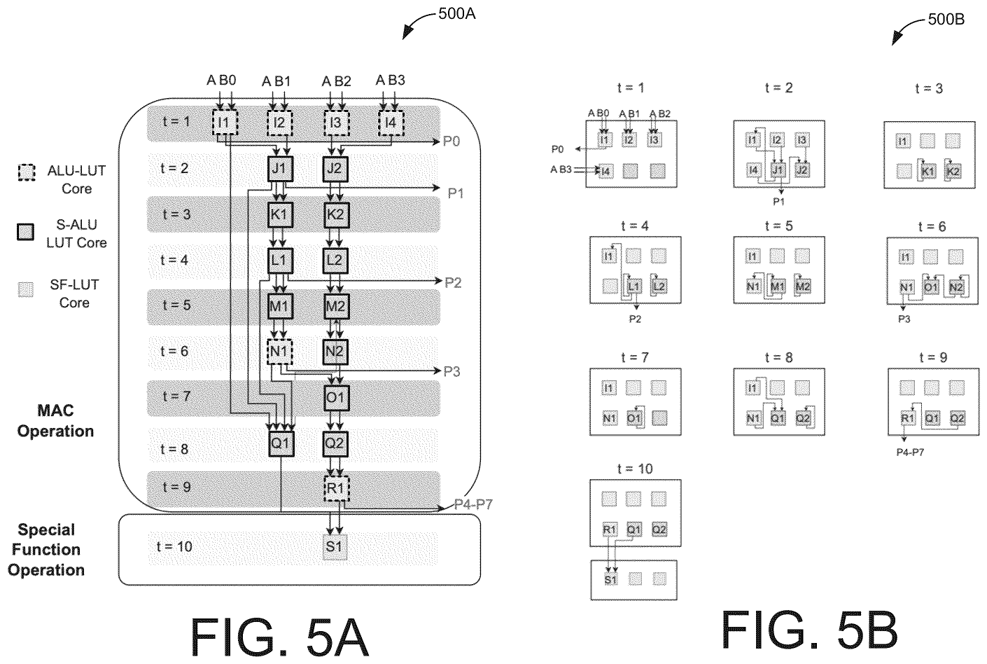

Turning now to FIGS. 5A and 5B, a schematic of an example data flow model 500A is shown alongside a more detailed example data execution schematic 500B, according to one aspect of the present disclosure. According to various aspects of the present disclosure, MAC operations can be performed on two 4-bit data operands (the input data). In various embodiments, in order to perform a MAC operation on the two 4-bit data operands, represented in the present embodiment as A and B, the A and B operands are split (or decomposed) into sections A3, A2, A1, A0, and B3, B2, B1, and B0, respectively. According to various aspects of the present disclosure, by splitting the data operands into sections, the data operands are decomposed which allows for the MAC operation to be partitioned and performed in smaller processing steps. For example, as shown in the present embodiment, rather than performing a MAC operation on the full operands A and B, the operands A and B are partitioned into smaller data structure AB0, AB1, AB2, and AB3, and the PIM architecture performs parallel operations on each of these smaller data structures. In various embodiments, the PIM architecture can then combine, or accumulate, the outputs from each of the smaller operations in order to achieve the appropriate MAC operation output as if the operation was performed on the A and B operations without partitioning. Moreover, in various embodiments, the system can perform one or more function approximation techniques for determining which LUT cores are most efficient for performing a particular task.

In at least one embodiment, the 4-bit multiplication is performed similarly to decimal multiplication. As illustrated in FIGS. 5A and 5B, a routing mechanism can be used to perform the MAC operation in a multi-stage pipeline. In at least one embodiment, the example data flow model 500A also illustrates how each process in the dataflow can be assigned a tag consisting of a letter and a number. As shown in the present embodiment, numbers 0, 1, 2, and 3, indicate various parallel operations performed by the cores in each clock cycle, and letters I, J, K, L, M, N, O, Q, R, and S, indicate the clock steps of LUT operations. In various embodiments, P0-P7 represent the MAC operation output of the MAC PE. According to various aspects of the present disclosure, during runtime, P0-P7 of the MAC operation is accumulated using the S-ALU-LUT core. In one embodiment, this accumulated output is later passed to the SF-LUT core in the SF PE (as indicated in the present embodiment at t=9) to perform functions such as activation, pooling, normalization operations, etc. In one example, the functions performed by the SF-LUT can be carried out in a single clock cycle, as indicated at t=10 in the present embodiment.

In particular embodiments, MAC operations performed inside the PIM cluster can be implemented in a combinational circuit manner by utilizing the multifunctional LUT cores such that the multiplication is implemented using a series of AND logic operations performed by the ALU-LUT cores and accumulation processes performed by the S-ALU-LUT cores. In various embodiments, utilizing the multifunctional S-ALU-LUT instead of ALU-LUT for the accumulation process improves the area, power, and latency overheads of the proposed architecture. According to various aspects of the present disclosure, and to further improve core utilization, overlapping of two consecutive accumulations in parallel for executing the MAC operation is enabled.

For the 4-bit inputs A and B, partial products can be obtained by multiplying each bit of input B with the entire 4-bit of input A operand. In one embodiment, the first partial product can be obtained by multiplying B0 with A3, A2, A1, A0, and the second partial product can be formed by multiplying B1 with A3, A2, A1, A0 (and so on for the third and fourth partial products). According to various aspects of the present disclosure, these partial products can be implemented with AND operator using ALU-LUT core as shown in the present embodiment. In various embodiments, the ALU-LUT core takes two 4-bit input operands and performs logical AND operations using the LUTs to provide 4-bit output. In particular embodiments, each of these operations can be performed in a single clock cycle during the execution. In various embodiments, these partial products can then be added by using 4-bit S-ALU-LUT cores to parallelize the addition process. For example, the first partial product can be added to the second partial product, and then this result can be added to the next partial product with carry-out (and so on for until the result is added to the final partial product). In various embodiments, and in response to adding the partial products via the S-ALU-LUT cores, an 8-bit output is generated which indicates the MAC value of the two 4-bit input operands A and B.

In particular embodiments, a combined multiplication and addition process can be executed in a 9-clock cycle pipeline, as represented in FIGS. 5A and 5B. Therefore, in various embodiments, a MAC PE can perform convolution operations that are implemented with a chain of MAC operations inside each MAC PE. In certain embodiments, and similar to how the PEs can be configured to perform convolutional operations, the MAC PE can also be configured to perform general matrix multiplication (GEMM) with a chain of MAC operations inside the MAC PE. Moreover, in various embodiments, the MAC PE can perform general matrix multiplication with a reconfigured routing scheme to produce the GEMM output for the given input operands.

As illustrated in both FIGS. 5A and 5B at the t=10 clock cycle, the output of the MAC operation from the MAC PE (at clock cycle t=9) is passed to the multifunctional SF-LUT core in the SF PE to implement a special function operation such as activation, pooling, normalization, etc. In one embodiment, a multiplexer can be used to select the different special function operations to be implemented in the SF-LUT. In particular embodiments, and based on the input from the multiplexer, the multifunctional LUT core can perform sigmoid, hyperbolic, or ReLU activation operations, as well as max pooling, average pooling, or normalization operations on the input data. According to various aspects of the present disclosure, these operations can be performed in a single clock cycle during the execution. In at least one example, the router can be used to enable the chain of operations required for MAC and activation operations inside the cluster.

In various embodiments, at least one advantage of the disclosed PIM architecture is that it enables a routing scheme and parallelization processing in order to efficiently utilize the cores inside the cluster. In a particular embodiment, the PIM architecture further leverages approximation techniques for performing the LUT operations. For example, given the LUTs are configured to be multifunctional, a mathematical operation of 2×3 can instead be performed as 2+2+2 via leveraging function approximation techniques (while the result is the same, the way in which the result is reached is fundamentally different at a computing level). Moreover, in one embodiment, the LUTs in the PIM architecture are capable of reprogramming at run-time to perform complex computational operations to implement CNNs at ultra-low latency. According to various aspects of the present disclosure, the cluster can be operatively configured to execute complicated arithmetic or logical tasks over single or multiple stages by combining the capability of multiple PE functionalities. Moreover, in particular embodiments, the PIM architecture can perform operations requiring higher resolution than the inputs and operations requiring more than two operands.

### Example Design Verification

In one embodiment, the architecture was verified using AISC via Verilog HDL implementation. In various embodiments, performance was evaluated using different metrics (such as operational latency, power consumption, and active area) from HDL synthesis on Synopsys Design Compiler using 28 nm standard cell library from TSMC, the results of which are presented below in Table I.

TABLE I
Characteristics of Multi-Functional Heterogeneous Hardware
Accelerator and its Components in 28 nm Technology Node

| | | | Active Area |
|---|---|---|---|
| Component | Delay (ns) | Power (mW) | (μm²) |
| ALU-LUT Core | 0.10 | 0.00177 | 8010 |
| S-ALU-LUT Core | 0.26 | 0.00497 | 13210 |
| SF-LUT Core | 0.7 | 0.01853 | 141304 |
| MAC PE | 0.92 | 0.01702 | 58460 |
| SF PE | 0.7 | 0.05559 | 1461500 |
| Example PIM | 1.62 | 0.19175 | 526140 |
| Cluster 1 (3 × 3) | | | |
| Example PIM | 1.62 | 0.46407 | 1461500 |
| Cluster 2 (5 × 5) | | | |
| Example PIM | 1.62 | 0.87255 | 2864540 |
| Cluster 3 (7 × 7) | | | |
| LUT Core | 0.8 | 2.7 | 4196.64 |
| LUT Cluster (MAC | 6.4 | 8.2-11 | 37769.81 |
| Operation) | | | |
| Intra-Subarray | 63.0 | 0.028 μJ/comm | N/A |
| Communication* | | | |
| Inter-Subarray | 148.5 | 0.09 μJ/comm | N/A |
| Communication | 196.5 | 0.12 μJ/comm | |
| for subarrays | 260.5 | 0.17 μJ/comm | |
| 1/7/15 hops away* | | | |

(*Represented in 28 nm technology node)

In one embodiment, it is observed that due to the different operational support provided by heterogeneous cores, the cores have different delay, area, and power metrics. In various embodiment, given the SF-LUTs process 8-bit data on 8-bit memory LUTs, which is different from the ALU and S-ALU cores, the SF-LUT has the highest delay, area, and power consumption. In certain embodiments, the ALU-LUT core is designed to process a pair of 4-bit data on 4-bit memory LUTs and has the least delay, area, and power consumption. According to various aspects of the present disclosure, and due to the same reasons, it can also be observed from Table I that the MAC PE has less delay, area, and power consumption compared to the SF PE. However, compared to the LUT core, the proposed cores have relatively less delay and power consumption, but the active area is about twice as large.

Table I also presents the cluster characteristics of the proposed PIM architecture cluster designs discussed herein (3×3, 5×5, and 7×7). In one embodiment, it can be observed that as the design exploration of the cluster sizes increases in the number of PEs (9, 25, and 49, respectively) the area and power consumption is increased. In various embodiments, these three PIM cluster designs are capable of performing 8-bit MAC operation and activation operation simultaneously and have the same delay due to the simultaneous parallel operational support from the architecture. For the cluster characteristics when the 8-bit MAC operation and activation operation are performed on the proposed architecture the delay is observed to be 1.62 ns, whereas for the LUT core to perform just the MAC operation the delay is 6.4 ns, which is almost 4 times faster implementation of MAC operation on multifunctional cores compared to the LUT core. According to various aspects of the present disclosure, it is observed that the multifunctional architecture is highly suitable for ultra-low latency, low-power applications such as real-time IoT devices, and edge devices. In particular embodiments, even though it is observed that the proposed architecture has more area than IMC LUT-based design it is still observed to achieve a lower area in the case of edge devices.

In various embodiments, and in order to perform an 8-bit MAC operation on a traditional 8-bit LUT architecture, it requires 1048576 (216× 16) pre-computed results of an operation. In certain embodiments, the PIM architecture disclosed herein may require 18432 (6×28×8) pre-computed results of an operation by using the six 4-bit M-LUT cores in the MAC PE. Therefore, in at least one embodiment, it can be observed that the proposed architecture is almost 86 times more area efficient than the traditional LUT architecture. In a particular embodiment, it can also be said that the dynamic power consumption for traditional LUT architecture is significantly larger than the proposed architecture. Although, in one embodiment, the traditional LUT architecture can perform the operation in a single clock cycle, the PIM architecture disclosed herein requires 9 clock cycles. Moreover, in various embodiments, the PIM architecture disclosed herein is configured to performing parallel operations and can perform multiple tasks simultaneously.

### Example Performance Evaluations

In various embodiments, comparative performance analysis of the PIM architecture disclosed herein was performed with respect to throughput and energy efficiency on LeNet, AlexNet, ResNet-18, -34, and -50 CNN algorithms, for a batch size of 64. In one embodiment, energy efficiency relates to the number of frames processed in the processor per unit of energy (Joules).

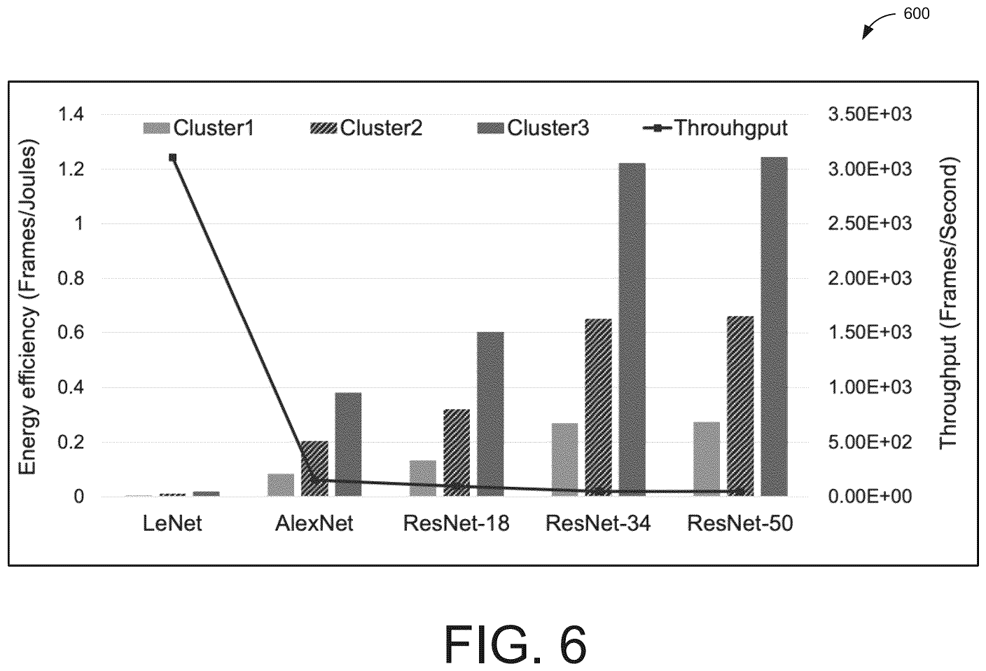

In one embodiment, FIG. 6 is a graph 600 which illustrates comparisons of the throughput (in Frames per second) and energy efficiency (in Frames per Joule) of inference on the various CNNs deployed on the disclosed multifunctional heterogeneous PIM architecture. In particular embodiments, the graph 600 in FIG. 6 also illustrates that the energy efficiency of the CNN algorithms is proportional to the depth of the network. For example, as the number of layers increases, more MAC, activation operations are needed to be performed which implies more parallelization to perform these operations. Therefore, and according to various aspects of the present disclosure, for a higher number of layers in the CNN algorithm, the energy efficiency achieved is high. In one embodiment, it is observed that LeNet, AlexNet, and ResNet 18 achieved the inference energy efficiency of 0.0011 Frames/Joule, 0.024 Frames/Joule, and 0.038 Frames/Joule respectively.

Continuing with FIG. 6, the graph 600 illustrates that the proposed architecture achieves better performance for CNN algorithms with a comparatively lower computational workload such as LeNet. However, in one embodiment, and for 8-layered AlexNet, the disclosed PIM architecture achieves an inference throughput of 150.3 Frames/s and the 50-layered ResNet algorithm achieves an inference throughput of 45.9 Frames/s. Accordingly, in particular embodiments, it can be said that the disclosed PIM architecture can achieve impressive performance while implementing MAC, activation operations, for the convolutional layers in the CNN/DNNs to process very efficiently due to its parallel processing ability. For example, ResNet-50, the largest network implemented on the PIM architecture, includes 50 layers with thirty-eight billion computations that can be processed within 10 ms on the proposed architecture.

Due to the similar design exploration and distribution of the tasks in the clusters a similar trend in terms of energy efficiency is observed for all three cluster implementations for all the CNNs. However, in one embodiment, due to the simultaneous parallel operational support of all the PEs in the cluster the throughput remains the same for all three cluster implementations.

### Example Inference Results

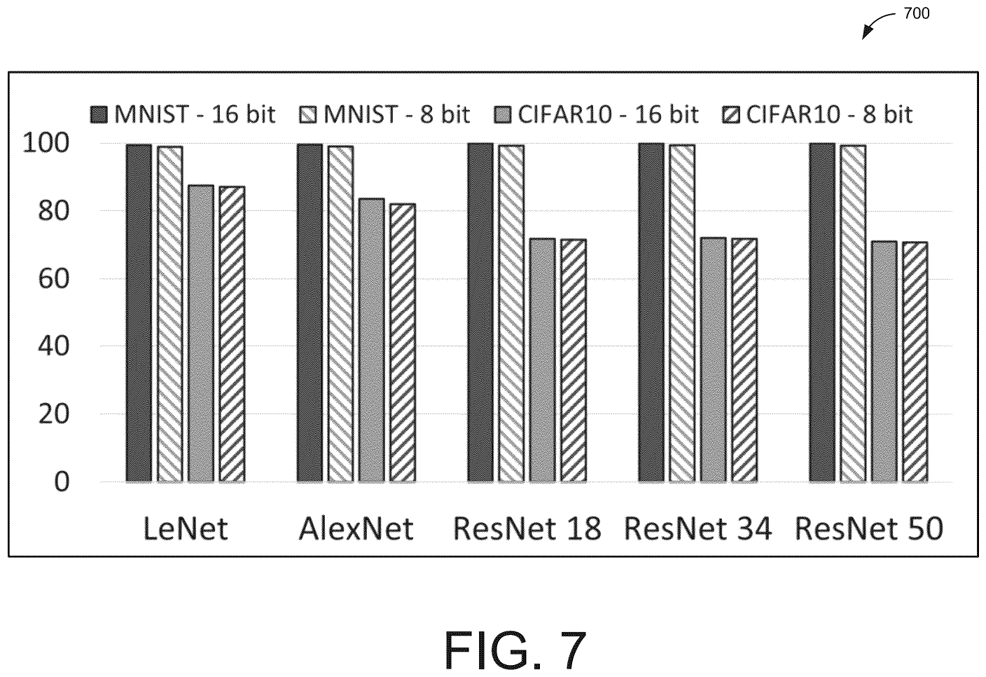

In one embodiment, the disclosed PIM architecture was evaluated for various state-of-the-art deep neural networks such as LeNet, AlexNet, ResNet-18, -34, -50. In certain embodiments, these deep learning algorithms were implemented on the proposed hardware accelerator using MNIST (28×28×1 dimensions), CIFAR-10 dataset (32×32×3 dimensions). According to various aspects of the present disclosure, FIG. 7 shows a graph 700 illustrating the top-5 accuracy comparison plots for 16-bit floating-point (FP), and 8-bit fixed-point data precision for both datasets. As shown in the graph 700, the accuracies obtained on the evaluated networks are very similar for 16-bit and 8-bit precision data (inputs and weights). In one embodiment, the top-1 accuracy obtained for the MNIST dataset when implemented on AlexNet is 98.89% and 99.43% for 16-bit and 8-bit precision respectively. In various embodiments, the top-1 accuracy obtained for the CIFAR-10 dataset when implemented on AlexNet is 83.5% and 82% for 16-bit and 8-bit precision respectively. In certain embodiments, the graph 700 illustrates that CNN accuracies for the CIFAR-10 dataset are noticeably lower when compared to the MNIST dataset. According to various aspects of the present disclosure, the performance degradation is around 10%-15% for all the CNNs deployed. In at least one embodiment, the accuracy of the CIFAR10 dataset, in general, is significantly lower than MNIST dataset due to the comparatively higher complexity of the dataset. Moreover, although higher accuracy with CIFAR-10 may be reported in the literature, it is with higher data precision than those adopted in the present embodiments.

### Example Hardware Acceleration Results

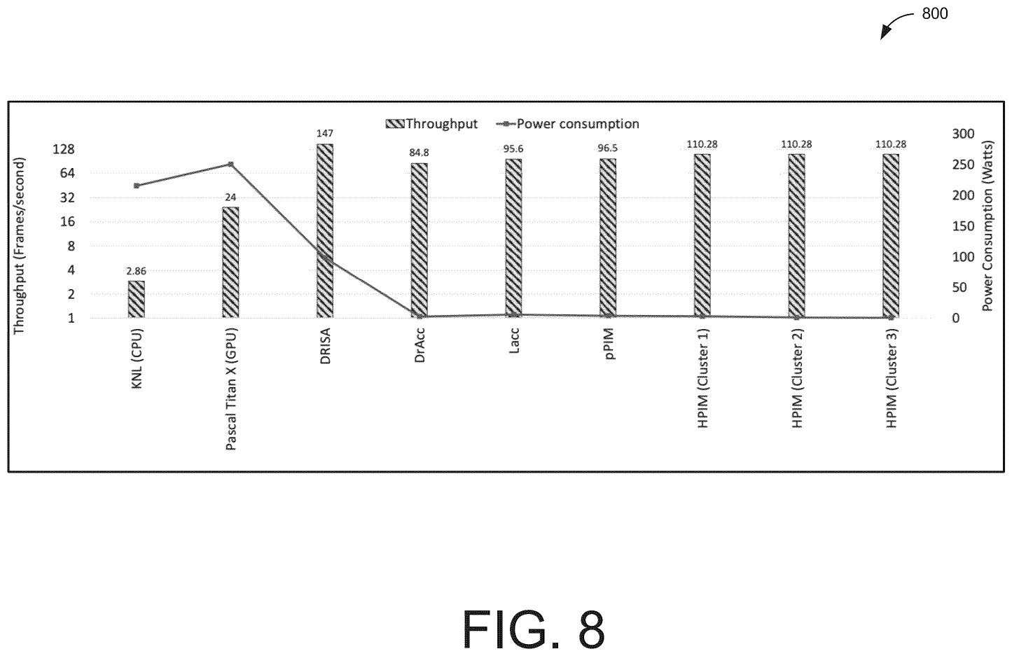

In one embodiment, FIG. 8 shows a graph 800 illustrating a performance comparison between the disclosed PIM architecture and other hardware accelerations for CNN implementation. In various embodiments, performance is evaluated by comparing the disclosed PIM architecture with state-of-the-art PIM accelerator architectures in terms of power consumption (Watt) and throughput (Frames/second), as illustrated in the graph 800.

In a particular embodiment, AlexNet was evaluated and implemented on the disclosed PIM architecture with the 8-bit width precision PIM architectures including DRAM-based bulk bit-wise processing devices DRISA and DrAcc, LUT-based PIM implemented on the DRAM platforms such as LAcc and the pPIM architecture.

In various embodiments, and among the PIMs studied here, a relatively higher throughput is observed for DRISA due to its ability to parallelize operations across multiple banks. In one embodiment, DrAcc implements 8-bit ternary precision inferences through very minimal circuit modifications which allows it to obtain high performance similar to that of pPIM. In certain embodiments, the benefits of adopting LUTs in order to utilize pre-calculated results instead of performing in-memory logic operations are convincingly demonstrated by LAcc and pPIM which achieved impressive inference performances (as shown in the graph 800).

In one embodiment, it can be observed that the throughput stays constant for all three cluster implementations due to the simultaneous parallel operational support provided by each PE in the cluster. In various embodiments, the disclosed PIM architecture utilizes the multifunctional heterogeneous memory LUTs to perform the CNN algorithms and is observed to have relatively higher AlexNet throughput than the LUT-based PIMs under comparison. Moreover, in one embodiment, it is also observed to have a much higher throughput when compared to other PIM architectures such as DRISA, Dracc, and Neural cache (as shown in the graph 800). In certain embodiments, a similar trend is observed for power consumption, where the disclosed PIM architecture is observed to have lower power consumption compared to the other conventional PIM architectures. In at least one embodiment, it is also observed that the disclosed PIM architecture outperforms LAcc and pPIM by a factor of almost 1.14 for AlexNet inference throughput. In one embodiment, the three proposed cluster sizes (3×3, 5×5, and 7×7) were also observed to achieve higher energy efficiencies by factors of about 2.4, 10, and 101, respectively, when compared to LAcc and pPIM implementation for AlexNet inference.

### CONCLUSION

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By a way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A system, comprising:
a plurality of processing-in-memory (PIM) clusters interconnected by a router in one or more dynamic random-access memory (DRAM) banks, wherein each PIM cluster of the plurality of PIM clusters comprises:
one or more multiply and accumulate (MAC) processing elements, wherein the one or more MAC processing elements comprise a plurality of MAC lookup table cores, and wherein each MAC lookup table core of the plurality of MAC lookup table cores is operatively configured to perform arithmetic logic in response to receiving a pair of data inputs; and
one or more special function (SF) processing elements, wherein the one or more SF processing elements comprise a plurality of SF lookup table cores, and wherein each SF lookup table core of the plurality of SF lookup table cores is operatively configured to perform one or more machine learning activation functions in response to receiving a single data input.

2. The system of claim 1, wherein the plurality of MAC lookup table cores further comprises:
one or more of a first arithmetic logic unit (ALU) lookup table core type, wherein the one or more of the first ALU lookup table core type is operatively configured to perform addition or multiplication operations on a respective pair of received 4-bit inputs in a single clock cycle; and
one or more of a second ALU lookup table core type, wherein the one or more of the second ALU lookup table core type is operatively configured to simultaneously perform both addition and multiplication operations on a respective pair of received 4-bit inputs in a single clock cycle.

3. The system of claim 2, wherein a MAC multiplexer is operatively configured to determine whether the one or more of the first ALU lookup table core type performs an addition or multiplication operation.

4. The system of claim 1, wherein the one or more machine learning activation functions comprise sigmoid functions, rectified linear unit functions, or hyperbolic functions.

5. The system of claim 4, wherein a SF multiplexer is operatively configured to determine which function, of the one or more machine learning activation functions, the plurality of SF lookup tables performs.

6. The system of claim 1, wherein the plurality of MAC lookup table cores and the plurality of SF lookup table cores are heterogeneously programmed to perform distinct operations.

7. The system of claim 1, wherein a particular PIM cluster of the plurality of PIM clusters comprises eight MAC processing elements and one SF processing element.

8. The system of claim 7, wherein the particular PIM cluster is operatively configured to perform a MAC operation in nine clock cycles.

9. The system of claim 8, wherein in response to performing the MAC operation, the particular PIM cluster is further operatively configured to perform a machine learning activation function operation in one clock cycle.

10. The system of claim 9, wherein the MAC operation and the machine learning activation function operation accelerate processing of a convolutional neural network.

11. A device, comprising:
one or more multiply and accumulate (MAC) in-memory processing elements, wherein the one or more MAC in-memory processing elements comprise a plurality of MAC lookup table cores, wherein each MAC lookup table core of the plurality of MAC lookup table cores is operatively configured to perform arithmetic logic in response to receiving a pair of data inputs, and wherein the plurality of MAC lookup table cores further comprises:
one or more of a first arithmetic logic unit (ALU) lookup table core type, wherein the one or more of the first ALU lookup table core type is operatively configured to perform addition or multiplication operations on a respective pair of received 4-bit inputs in a single clock cycle; and
one or more of a second ALU lookup table core type, wherein the one or more of the second ALU lookup table core type is operatively configured to simultaneously perform both addition and multiplication operations on a respective pair of received 4-bit inputs in a single clock cycle.

12. The device of claim 11, wherein a MAC multiplexer is operatively configured to determine whether the one or more of the first ALU lookup table core type performs an addition or multiplication operation.

13. The device of claim 11, wherein the device further comprises one or more special function (SF) in-memory processing elements, wherein the one or more SF in-memory processing elements comprise a plurality of SF lookup table cores, and wherein each SF lookup table core of the plurality of SF lookup table cores is operatively configured to perform one or more machine learning activation functions in response to receiving a single data input.

14. The device of claim 13, wherein the one or more machine learning activation functions comprise sigmoid functions, rectified linear unit functions, or hyperbolic functions.

15. The device of claim 14, wherein a SF multiplexer is operatively configured to determine which function, of the one or more machine learning activation functions, the plurality of SF lookup tables performs.

16. The device of claim 14, wherein the plurality of MAC lookup table cores and the plurality of SF lookup table cores are heterogeneously programmed to perform distinct operations.

17. The device of claim 14, wherein eight MAC in-memory processing elements and one SF in-memory processing element are interconnected in one or more dynamic random-access memory (DRAM) banks DRAM via a router to form a processing-in-memory (PIM) cluster.

18. The device of claim 17, wherein the PIM cluster is operatively configured to perform a MAC operation in nine clock cycles.

19. The device of claim 18, wherein in response to performing the MAC operation, the PIM cluster is further operatively configured to perform a machine learning activation function operation in one clock cycle.

20. The device of claim 19, wherein the MAC operation and the machine learning activation function operation accelerate processing of a convolutional neural network.
